(19) United States
(12) Patent Application Publication
(10) Pub. No.: US 2005/0181645 A1
(43) Pub. Date: Aug. 18, 2005

(54) Tube-Shaped Universal-Serial-Bus (USB) Flash-Memory Device with End Clips that Hold an internal Printed-Circuit-Board (PCB)

(75) Inventors: Jim Chin-Nan Ni, San Jose, CA (US); Ren-Kang Chiou, Fremont, CA (US)

Correspondence Address: STUART T AUVINEN, 429 26TH AVENUE, SANTA CRUZ, CA, 95062-5319, US

(73) Assignee: SUPER TALENT ELECTRONICS INC., San Jose, CA (US)

(21) Appl. No.: 10/908,106

(22) Filed: Apr. 27, 2005

Related U.S. Application Data
(63) Continuation-in-part of application No. 10/605,146, filed on Sep. 11, 2003, now Pat. No. 6,854,984.
(63) Continuation-in-part of application No. 10/904,207, filed on Oct. 28, 2004.
(63) Continuation-in-part of application No. 10/907,204, filed on Mar. 24, 2005.
(63) Continuation-in-part of application No. 10/907,700, filed on Apr. 12, 2005.
(63) Continuation-in-part of application No. 10/964,412, filed on Oct. 12, 2004.

(51) Int. Cl. H01R 12/00

(52) U.S. Cl. 439/79

(57) ABSTRACT

A metal-tube flash-memory-drive device has an integrated slim Universal-Serial-Bus (USB) connector that fits into a standard USB socket. The slim USB connector has 4 metal contacts. The 4 metal contacts are on a circuit board that slides into a slot on a front holder to form the USB connector. Components are pre-mounted onto the circuit board. The circuit board is fitted into the slot in the front holder and then both are inserted into a front opening of a metal tube. A rear holder is inserted into a rear opening of the metal tube to seal the circuit board inside the metal tube. The 4 metal contacts may also be an integral part of a front holder-connector that fits over and edge of the circuit board. A metal or plastic shield may be added over the USB connector to cover the 4 metal contacts.

### RELATED APPLICATIONS

This application is a continuation-in-part of the application for “Slim USB Connector with Spring-Engaging Depressions, Stabilizing Dividers and Wider End Rails for Flash-Memory Drive”, U.S. Ser. No. 10/605,146, filed Sep. 19, 2003, now U.S. Pat. No. 6,854,984, and “Manufacturing Methods for Ultra-Slim USB Flash Memory Card with Supporting Dividers or Underside Ribs”, U.S. Ser. No. 10/904,207, filed Oct. 28, 2004, and “Narrow Universal-Serial-Bus (USB) Flash-Memory Card with Straight Sides using a Ball-Grid-Array (BGA) Chip”, U.S. Ser. No. 10/907,204, filed Mar. 24, 2005, and “Universal-Serial-Bus (USB) Flash-Memory Device with Metal Wrap Formed over Plastic Housing”, U.S. Ser. No. 10/907,700, filed Apr. 12, 2005, and “Portable Computer Peripheral Apparatus With Reinforced Connecting Ring”, U.S. Ser. No. 10/964,412, filed Oct. 12, 2004.

### FIELD OF THE INVENTION

This invention relates to reduced-size Universal-Serial-Bus (USB) connectors, and more particularly to flash-memory-drive cards having a metal body tube.

### BACKGROUND OF THE INVENTION

Flash memory devices have found wide-spread use. Large, 1 G-Byte chips using flash-memory technologies with electrically-erasable programmable read-only memory (EEPROM) are available. Small flash-memory cards have been designed that have a connector that can plug into a specialized reader, such as for compact-flash, secure-digital, memory stick, or other standardized formats.

Flash memory cards are being sold that contain a USB connector. Such USB-flash memory cards do not require a specialized reader but can be plugged into a USB connector on a personal computer (PC) or other hosting device. These USB-flash memory cards can be used in place of floppy disks and are known as USB key drives, USB thumb drives, and a variety of other names. These USB-flash cards can have a capacity of more than ten floppy disks in an area not much larger than a large postage stamp.

FIG. 1 shows a bottom view of assembly of a male slim USB connector that is integrated with a circuit-board substrate of a flash memory card. Flash memory chip 75 may be a 128 Mega-byte non-volatile chip or may have some other capacity. Controller chip 78 contains a flash-memory controller that generates signals to access memory locations within flash memory chip 75. Controller chip 78 also contains a USB interface controller that serially transfers data to and from flash memory chip 75 over a USB connection.

A USB connector may be formed on board 60, which is a small circuit board with chips 75, 78 mounted thereon. Multi-layer printed-circuit board (PCB) technology can be used for board 60. Metal contacts carry the USB signals generated or received by controller chip 78. USB signals include power, ground, and serial differential data D+, D−.

The USB flash-memory card is assembled from PCB board 60 and its components, and lower case 65, which are sandwiched together to form the flash-memory card. The bottom surface of board 60 is visible in FIG. 1.

Flash memory chip 75 and controller chip 78 are mounted on the reverse (bottom) side of board 60, which can be a multi-layer PCB or similar substrate with wiring traces. The 4 USB contacts are formed on the top side of board 60 and are not visible in this bottom view. Since most components are mounted on the bottom side of board 60 opposite the top side with the USB metal contacts, board 60 does not need a plastic cover over its top side. This allows the flash-memory card to have a lower profile or even a co-planar top surface.

Extension 61 of board 60 has a width that approximately matches the width of the connector substrate and the metal tube in a male USB connector, about 12.4 mm. Metal USB contacts (not visible) are formed on the top side of extension 61 to act as the USB metal contacts of the male slim USB connector. End 72 of board 60 is inserted into the female USB connector.

Lower case 65 also includes extended region 80. Light-emitting diode (LED) 93 can be mounted on board 60, such as on the bottom side with other components, or extending from an edge of board 60.

While traditional USB connectors have metal tubes around a connector substrate, USB flash-memory drives are often made from plastic housings. A USB flash-memory drive may have a metal tube around extension 61, but a plastic housing such as lower case 65 around for the remaining portion of the USB device. Having the metal-wrapped connector with the plastic housing may be aesthetically unappealing, and the plastic housing may be less durable than the metal-wrapped USB connector. A visible seam may exist where two or more plastic cases are joined together. The plastic case may be less durable than metal and show signs of wear such as scratches and nicks. The USB device may even crack and fail due to strain at plastic interfaces or joins between plastic parts.

What is desired is a metal-encased USB flash-memory device. A USB flash-memory device with a metal cover is desirable. A USB flash device that has a circuit board mounted inside a metal tube is desirable.

### BRIEF DESCRIPTION OF THE DRAWINGS

FIG. 1 shows a bottom view of assembly of a male slim USB connector that is integrated with a circuit-board substrate of a flash memory card.

FIGS. 2A-D show a USB flash-memory device with a metal tube and connector pads integrated on the circuit board.

FIG. 3 shows a full metal shield around the USB connector of the USB flash-memory device.

FIG. 4 shows a full plastic shield around the USB connector of the USB flash-memory device.

FIG. 5 shows a partial metal shield around the USB connector of the USB flash-memory device.

FIGS. 6A-B show assembly using a discrete USB connector and a metal tube.

FIG. 7 shows a full metal shield around the USB connector of the front holder-connector.

FIG. 8 shows a full plastic shield around the USB connector of the front holder-connector.

FIG. 9 shows a partial metal shield around the USB connector of the front holder-connector.

FIGS. 10A-B show a USB connector mounted to the PCB before insertion into the metal tube.

FIGS. 11A-B show a USB connector mounted to the PCB before insertion into the metal tube and an alternate litepipe.

FIGS. 12A-B show a USB connector mounted to the PCB before insertion into the metal tube and an alternate litepipe integrated with the rear holder.

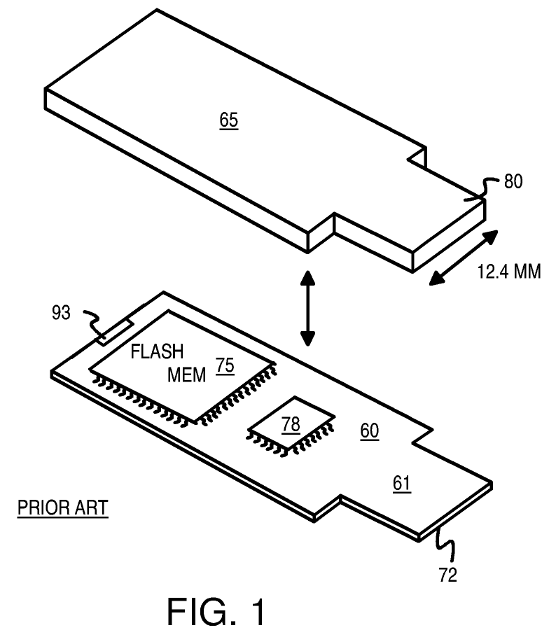

### DETAILED DESCRIPTION

The present invention relates to an improvement in USB flash drives. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

The inventors have realized that manufacturing costs may be reduced by inserting the circuit board of a USB flash-memory device into a metal tube. This saves the cost and tooling for molding two plastic half-cases and snapping these two half-cases together around the circuit board. The metal tube can provide a smoother appearance than the plastic case, and seams or molding lines can be eliminated, for a better visual appearance. Using a single metal tube rather than two plastic half-cases can result in stronger structure integrity. Holders or clips can be inserted onto the ends of the circuit board to support the circuit board within the metal tube. An easier, snap-together manufacturing method may be used with the metal tube USB flash-memory device.

The USB connector can be separate from the metal tube. The USB connector can be separate from the circuit board, or can use an extension of the circuit board for the metal connectors. The circuit-board extension can first be fitted into a plastic holder that forms parts of the USB connector and itself fits into an end of the metal tube. The USB connector can be left uncovered, or a metal wrap or a plastic shield can be added as a shield to cover the USB connector. Another holder can be inserted into the far end of the metal tube to hold the circuit board from the other (non-connector) end.

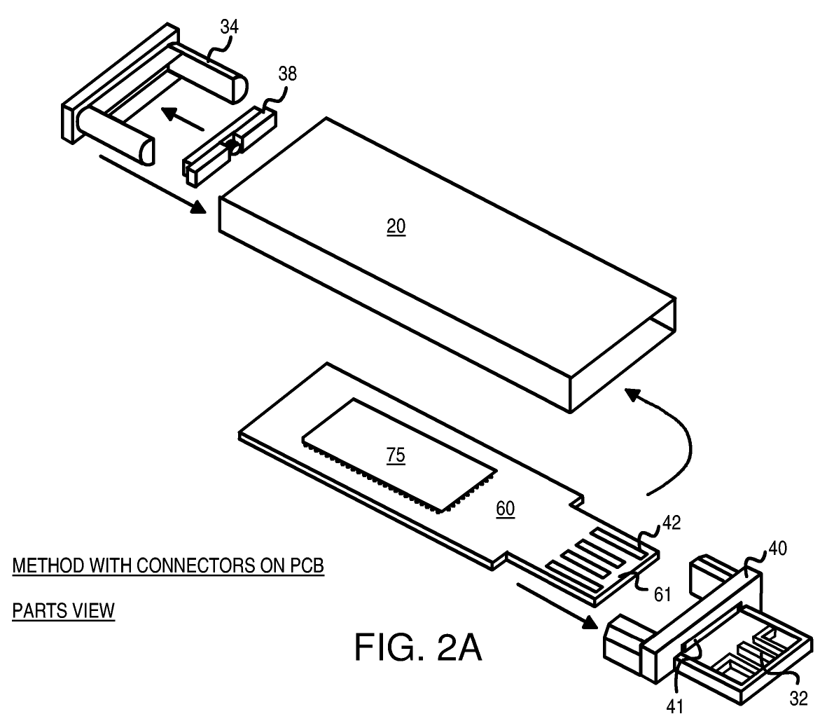

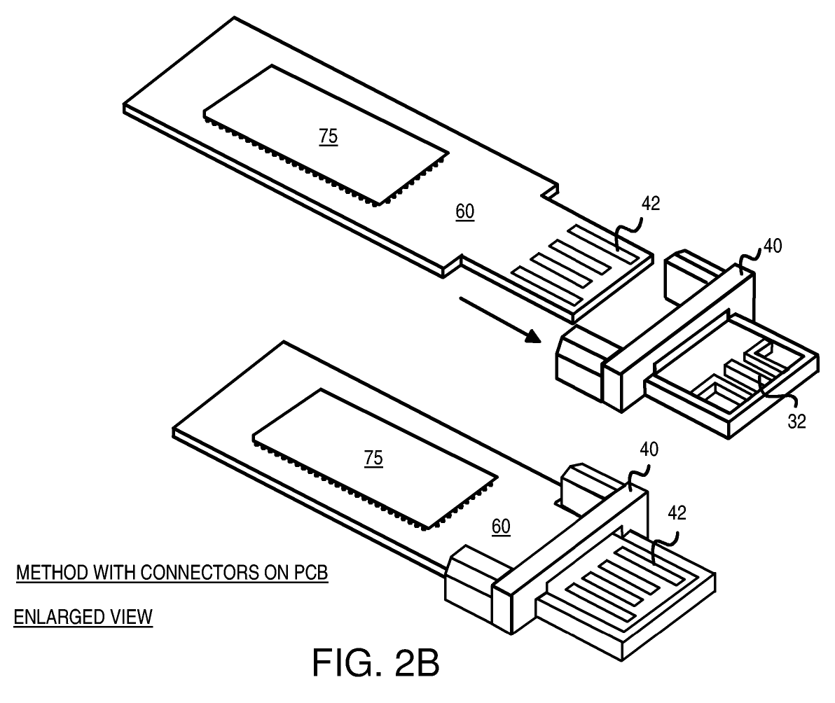

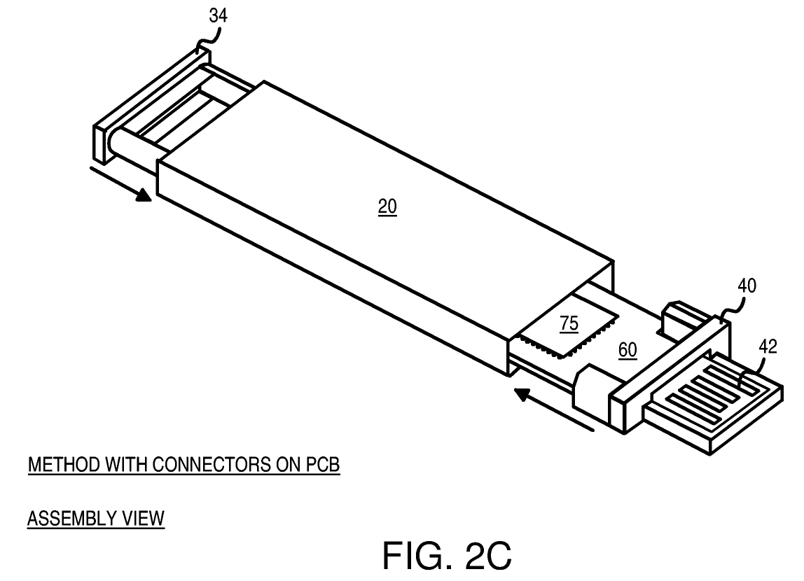

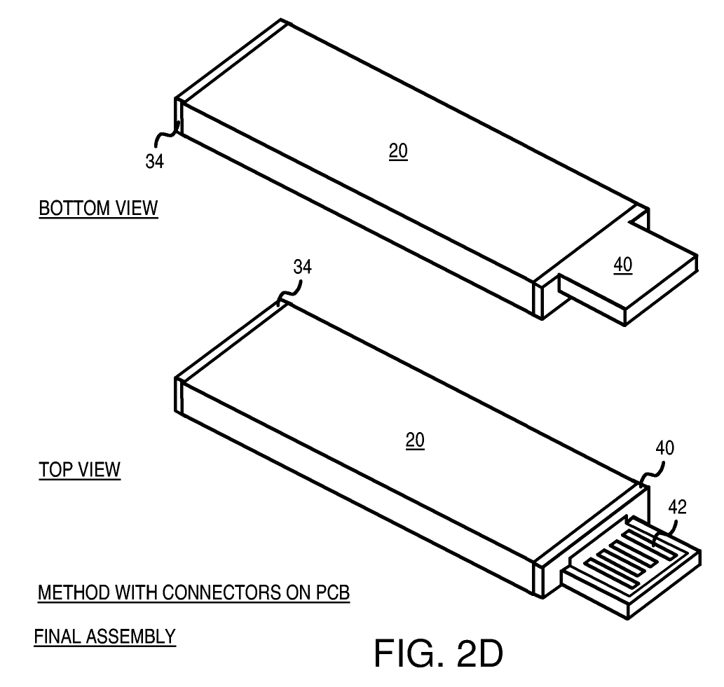

FIGS. 2A-D show a USB flash-memory device with a metal tube and connector pads integrated on the circuit board. In FIG. 2A, flash memory chip 75 is a 128 Mega-byte non-volatile memory chip or may have a die with some other capacity and can be packaged in a variety of packages, such a BGA, small-outline, leadless, etc. A controller chip (not shown) contains a flash-memory controller that generates signals to access memory locations within flash memory chip 75. The controller chip also contains a USB interface controller that serially transfers data to and from flash memory chip 75 over a USB connection.

Multi-layer printed-circuit board (PCB) technology can be used for board 60. Metal contacts 42 carry the USB signals generated or received by the controller chip. USB signals include power, ground, and serial differential data D+, D−.

The USB flash-memory card is assembled from PCB board 60 and other components, including metal tube 20, front holder 40, rear holder 34, and litepipe 38. The top surface of board 60 is visible in FIG. 2A. Flash memory chip 75 and the controller chip 79 can be mounted to the top side of board 60 as shown, or can be mounted to the reverse side or chips may be mounted to both sides. Board 60 can be a multi-layer PCB or similar substrate with wiring traces. The 4 USB contacts are formed on the top side of board 60.

An LED (not shown) can be mounted on board 60, such as by the rear edge of board 60. The LED can be fitted into a notch in litepipe 38 during assembly so that the light from the LED is carried by litepipe 38 to be visible externally to a user. A region of reduced thickness (not shown) or an opening may be formed in rear holder 34 to create a light window for the LED.

Supporting ridges 32 on front holder 40 provide mechanical support to insertion end 61 of board 60 around metal contacts 42. During assembly, extension 61 of board 60 is inserted into slot 41 in front holder 40 so that extension 61 of board 60 becomes part of the USB connector that protrudes from the USB flash-memory device. As shown in the enlarged view of FIG. 2B, metal contacts 42 on extension 61 are exposed and available for mating with metal contacts on a USB socket when the USB connector is inserted into a USB socket. Front holder 40 also provides mechanical support for board 60 when board 60 and front holder 40 are together inserted into the front opening of metal tube 20.

After board 60 and front holder 40 are together inserted into the front opening of metal tube 20, litepipe 38 inserted into rear holder 34 are both inserted into the rear opening of metal tube 20. Litepipe 38 may fit in a groove in rear holder 34, and rear holder 34 may contain clips to hold the rear edge of board 60 when fully assembled. Alternately, litepipe 38 may be inserted through the rear opening of metal tube 20 and fit over an LED on the rear edge of board 60 after board 60 is fully inserted into metal tube 20, and then rear holder 34 may be inserted into the rear opening of metal tube 20. Litepipe 38 could also be an integral part of rear holder 34.

Inward pressure may be applied to rear holder 34 and to front holder 40 to push them together and firmly into the rear and front openings of metal tube 20, as shown in FIG. 2C. The final assembly shown in FIG. 2D has metal contacts 42 exposed from the top of the USB connector that is formed by part of front holder 40. Metal tube 20 forms a smooth surface to the USB flash-memory device while rear holder 34 seals the rear opening of metal tube 20. When metal tube 20 has no seams, the device has no seams between rear holder 34 and front holder 40, so a smooth device is produced.

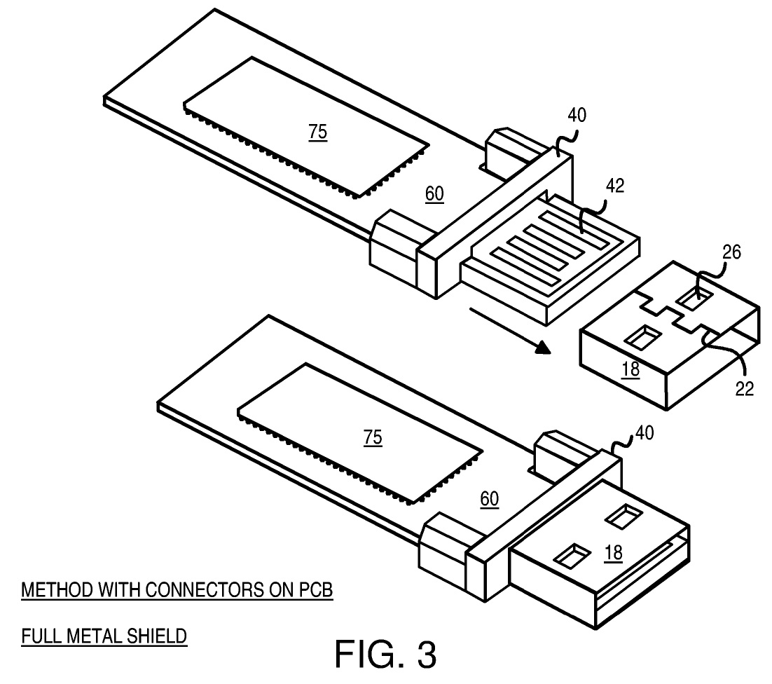

FIG. 3 shows a full metal shield around the USB connector of the USB flash-memory device. The USB connector plug formed by front holder 40 and extension 61 of board 60 may be left fully exposed as shown in the final assembly of FIG. 2D. Alternately, a metal wrap or shield may be inserted over the USB connector plug.

The USB connector plug of front holder 40 is fitted into metal shield 18 (or metal shield 18 is fitted over the USB plug end of front holder 40). USB holes 26 in metal shield 18 mate with USB clips in the USB socket when inserted. Seam 22 may be a forming line located on metal shield 18.

A more sturdy plug connection may result due to metal shield 18. Also metal shield 18 may provide protection of metal contacts 42 and front holder 40 from damage by rough usage.

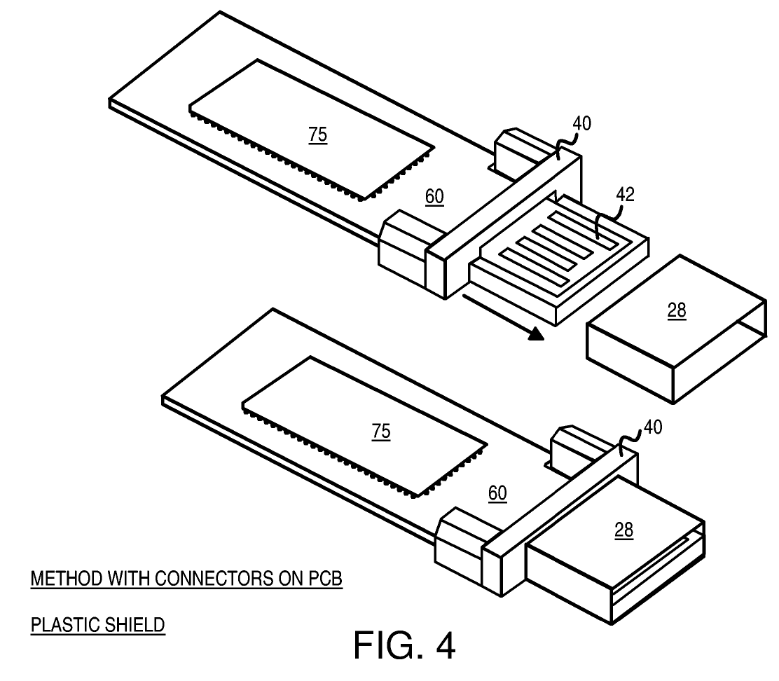

FIG. 4 shows a full plastic shield around the USB connector of the USB flash-memory device. Plastic shield 28 is inserted over the USB connector plug end of front holder 40, providing protection for metal contacts 42. Plastic shield 28 emulates the metal shield of a standard USB plug or of a reduced-size USB plug. USB holes may or may not be present in plastic shield 28.

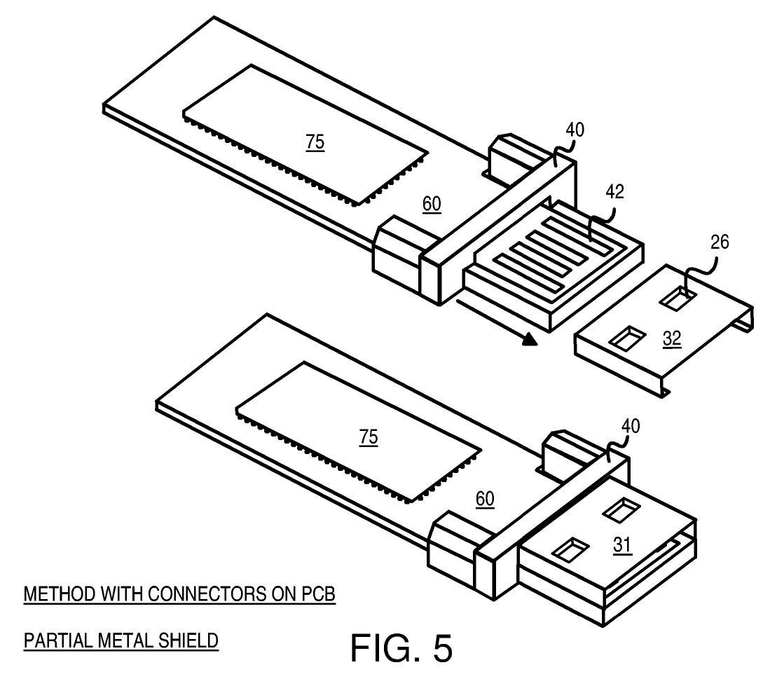

FIG. 5 shows a partial metal shield around the USB connector of the USB flash-memory device. Partial metal shield 31 has a top and sides but does not have a full bottom. Partial metal shield 31 slides over the USB connector plug end of front holder 40. A groove can be formed on each lateral side of front holder 40 to mate with partial metal shield 31, which slides through the groove to form the USB plug. Alternatively, adhesive may be used to secure the parts. Partial metal shield 31 provides protection for metal contacts 42. USB holes 26 may or may not be present in partial metal shield 31.

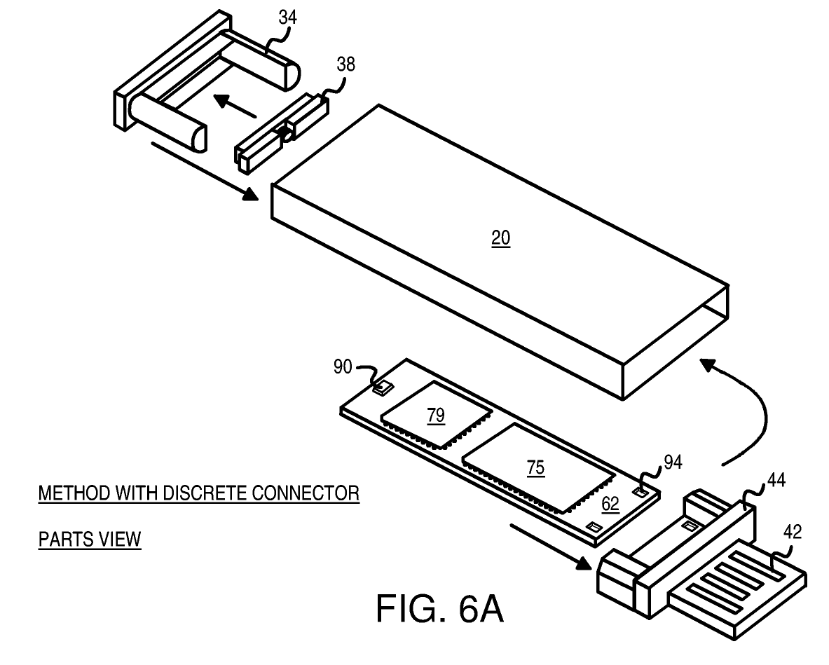

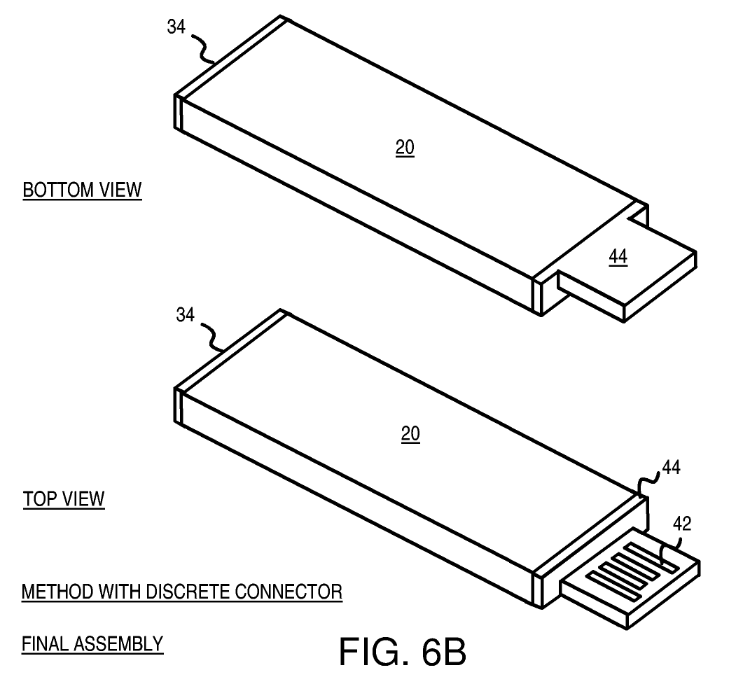

FIGS. 6A-B show assembly using a discrete USB connector and a metal tube. Rather than form the USB connector from an extension of the PCB, the USB connector can be separate from the circuit board. In FIG. 6A, board 62 has flash memory chip 75 and controller chip 79 mounted to the top surface of board 62.

Front holder-connector 44 has an integral USB connector that includes metal contacts 42 that mate with USB metal contacts on the USB socket. Metal contacts 42 are separate from board 62, but are electrically connected through front holder-connector 44 to traces or edge connectors (not shown) on board 62 that match the position of metal contacts (not shown) on front holder-connector 44.

Board 62 is fitted into front holder-connector 44 during assembly, as shown in FIG. 6A. Alignment holes 94 on board 62 fit into matching tabs or metal guide pins on front holder-connector 44 to secure board 62 to front holder-connector 44. Metal around alignment holes 94 may be soldered to the metal guide pins of front holder-connector 44. A groove (not shown) may be provided on front holder-connector 44 to receive an edge of board 62 to facilitate assembly.

The pre-assembly of board 62 and front holder-connector 44 can be inserted into the front end of metal tube 20. Litepipe 38 is inserted into the rear opening of metal tube 20 to fit over LED 90 mounted to board 62. Rear holder 34 is then inserted into the rear opening of metal tube 20.

FIG. 6B shows the final assembly with smooth sides provided by metal tube 20. Metal contacts 42 are exposed from the top of the USB connector that is formed by front holder-connector 44. Metal tube 20 forms a smooth surface to the USB flash-memory device while rear holder 34 seals the rear opening of metal tube 20. When metal tube 20 has no seams, the device has no seams between rear holder 34 and front holder-connector 44, so a smooth device is produced.

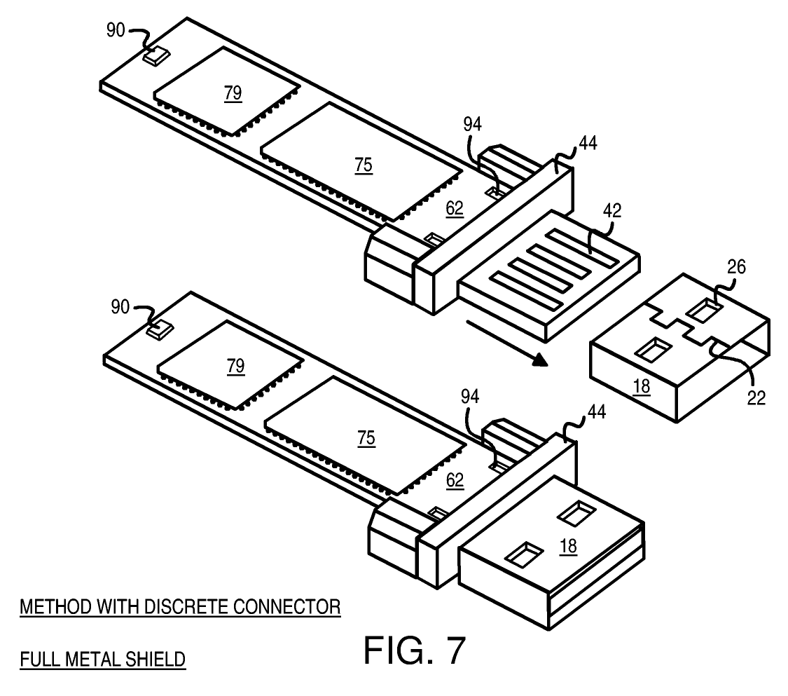

FIG. 7 shows a full metal shield around the USB connector of the front holder-connector. The USB connector plug is formed from front holder-connector 44 while board 62 is inserted into front holder-connector 44. The USB connector of front holder-connector 44 may be left fully exposed as shown in the final assembly of FIG. 6B. Alternately, a metal wrap or shield may be inserted over the USB connector plug.

The USB connector plug of front holder-connector 44 is fitted into metal shield 18 (or metal shield 18 is fitted over the USB plug end of front holder-connector 44). USB holes 26 in metal shield 18 mate with USB clips in the USB socket when inserted. Seam 22 may be located on metal shield 18.

A more sturdy plug connection may result due to metal shield 18. Also metal shield 18 may provide protection of metal contacts 42 and front holder-connector 44 from damage by rough usage.

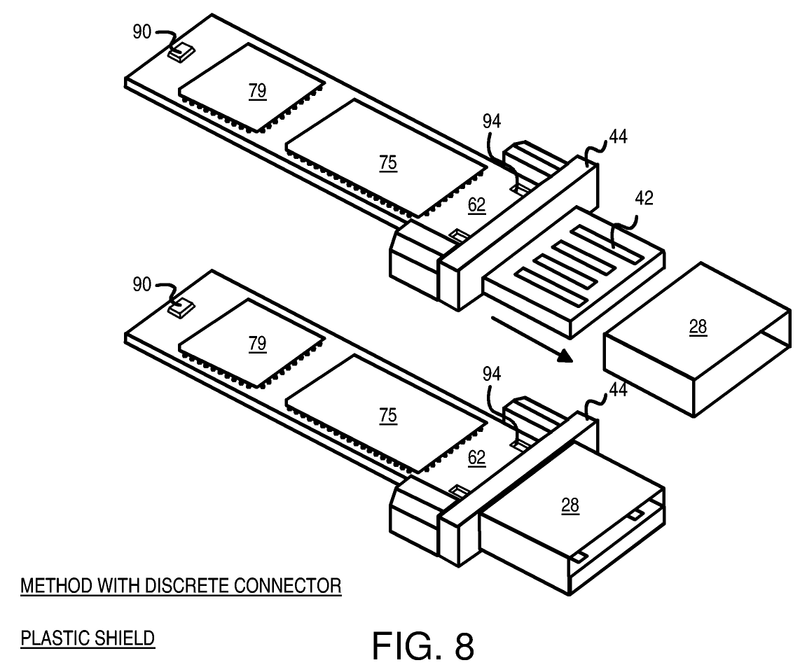

FIG. 8 shows a full plastic shield around the USB connector of the front holder-connector. Plastic shield 28 is inserted over the USB connector plug end of front holder-connector 44, providing protection for metal contacts 42. Plastic shield 28 emulates the metal shield of a standard USB plug or of a reduced-size USB plug. USB holes may or may not be present in plastic shield 28.

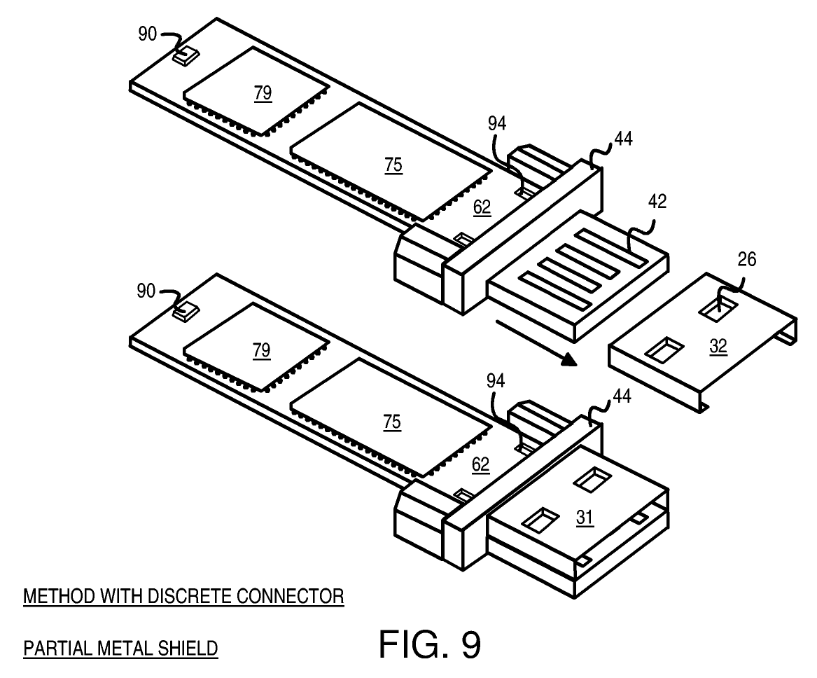

FIG. 9 shows a partial metal shield around the USB connector of the front holder-connector. Partial metal shield 31 has a top and sides but does not have a full bottom. Partial metal shield 31 slides over the USB connector plug end of front holder-connector 44. Partial metal shield 31 provides protection for metal contacts 42. USB holes 26 may or may not be present in partial metal shield 31.

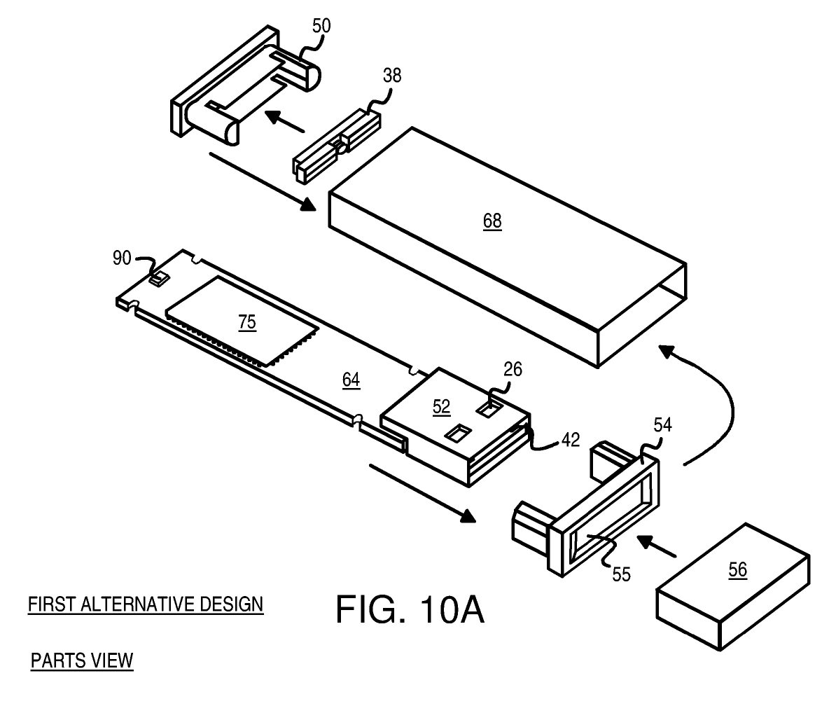

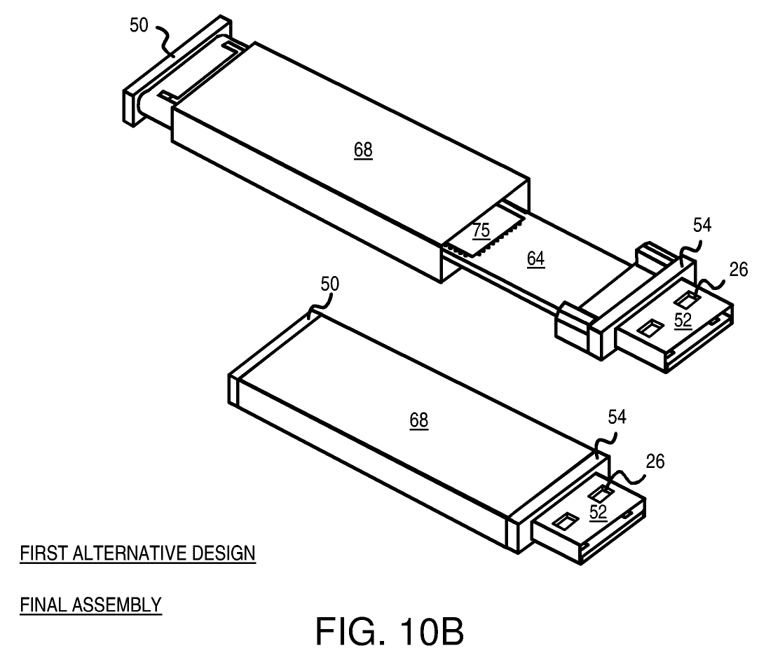

FIGS. 10A-B show a USB connector mounted to the PCB before insertion into the metal tube. Board 64 has flash-memory chip 75 and LED 90 mounted on it. USB connector 52 is also mounted directly to board 64, such as by soldering. USB connector 52 can be a standard USB connector or a modified USB connector such as a half-height connector. USB holes 26 are formed in a metal wrap around USB connector 52 to protect metal contacts 42.

During assembly, USB connector 52 on board 64 is fitted through large slot 55 in front holder 54. This produces a sub-assembly of board 64, USB connector 52, and front holder 54 that is fitted into the front opening of metal tube 68, as shown in FIG. 10B. Litepipe 38 is inserted over LED 90, either before board 64 is inserted into metal tube 68 or after, and rear holder 50 is inserted into the rear opening of metal tube 68.

Removable cap 56 (FIG. 10A) may be slid over USB connector 52 of the final assembly. Removable cap 56 can be removed by an end-user before insertion of USB connector 52 into a USB socket, and can be replaced over USB connector 52 for protection during transport of the USB flash-memory device.

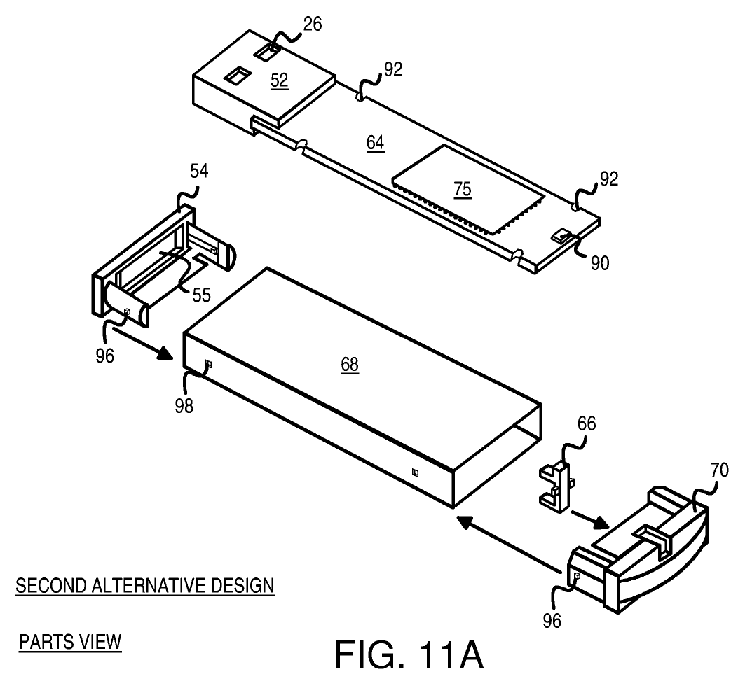

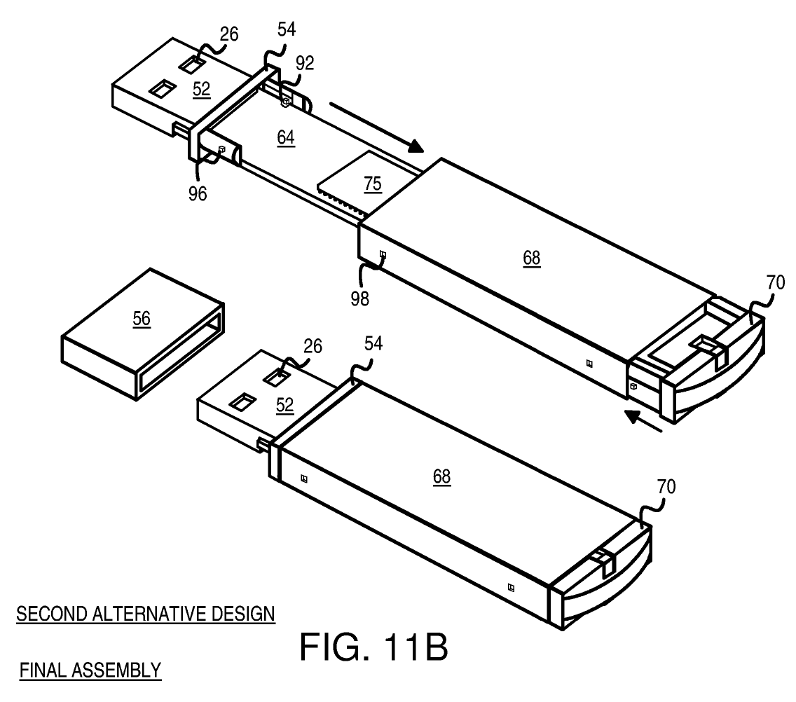

FIGS. 11A-B show a USB connector mounted to the PCB before insertion into the metal tube and an alternate litepipe. Board 64 has flash-memory chip 75 and LED 90 mounted on it. USB connector 52 is also mounted directly to board 64, such as by soldering. USB connector 52 can be a standard USB connector or a modified USB connector such as a half-height connector. USB holes 26 are formed in a metal wrap around USB connector 52 to protect metal contacts 42.

During assembly, USB connector 52 on board 64 is fitted through large slot 55 in front holder 54. This produces a sub-assembly of board 64, USB connector 52, and front holder 54 that is fitted into the front opening of metal tube 68, as shown in FIG. 11B. Litepipe 66 is inserted over LED 90, either before board 64 is inserted into metal tube 68 or after, and rear holder 70 is inserted into the rear opening of metal tube 68. Litepipe 66 may clip over LED 90 on board 64 for a more secure attachment and fit through an opening in rear holder 70.

Metal tube 68 can have tabs 98 formed, such as by making a U-shape cut in the metal and pushing the center of the U-shape inward for form the tab. Tabs 98 can snap into notches 96 on rear holder 70 and front holder 54 when inserted into metal tube 68.

Notches 92 on board 64 can fit into other tabs (not shown) on front holder 54 and rear holder 70 when board 64 is inserted into front holder 54 and rear holder 70.

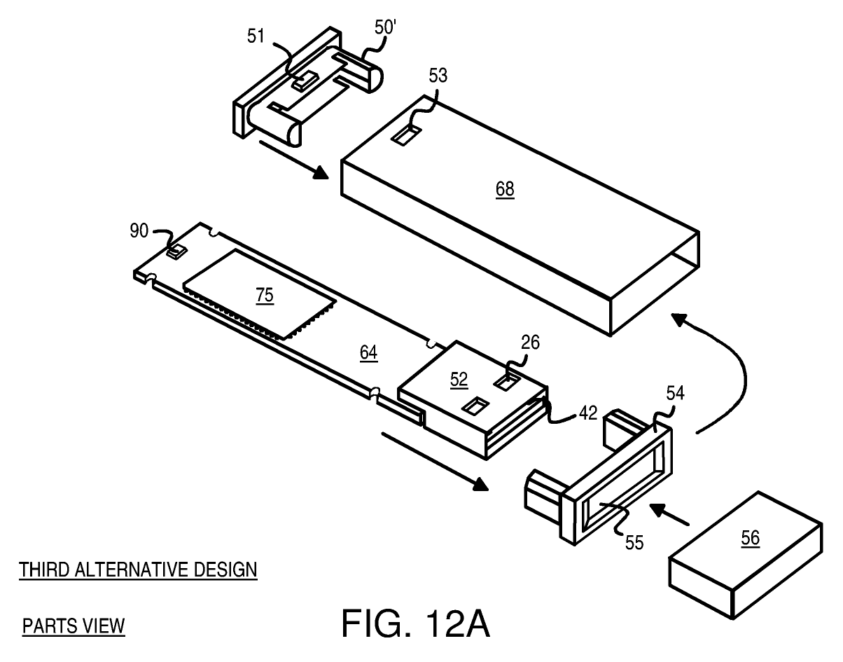

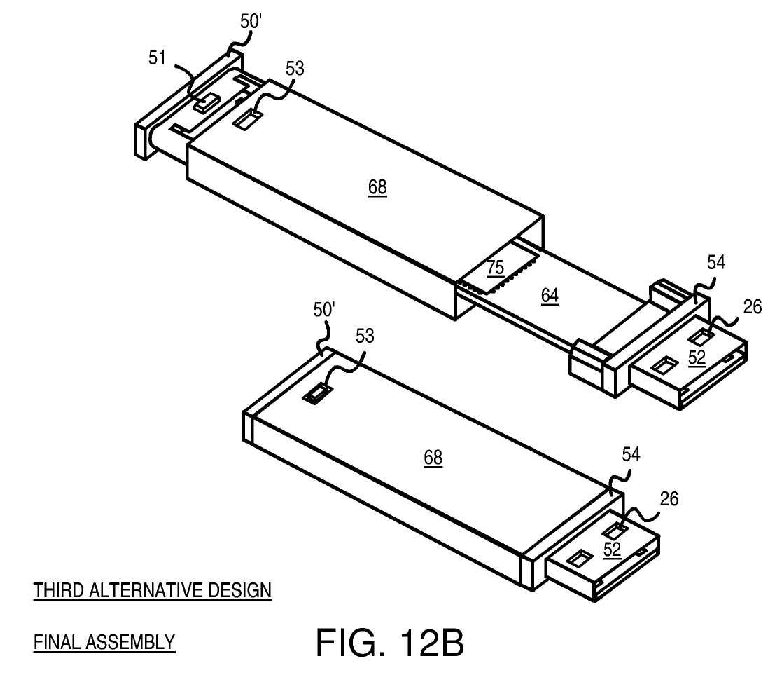

FIGS. 12A-B show a USB connector mounted to the PCB before insertion into the metal tube and an alternate litepipe integrated with the rear holder.

Litepipe 51 is integrated with rear holder 50′, which is inserted over LED 90 on board 64 when inserted into metal tube 68. Receiving hole 53 may be made in metal tube 68, such as on the top as shown, for allowing light from litepipe 51 to pass through. Alternately, the litepipe could direct the LED light through an opening in rear holder 50′.

Lead-Free Process Considerations

The element lead (Plumbium, Pb) is indicated as a hazardous material. Legislatives would like to remove this material within a couple of years, such as from the European Union and Japan after January 2008 or earlier.

The traditional USB plug which has plastic substrate during PCBA process will be shrunk and warped at a temperature of about 240° C. (peak temp of lead-free solder paste), therefore such a USB plug is not suitable for lead-free process.

The USB plug doesn't have the plastic substrate during PCBA process and may use a different PCB material to provide a better temperature resistance to the peak temp of 240° C. of the lead-free process. For lead-free processes, surface mount components as well as BGAs don't contain lead in their pins or balls. After the PCBA process, the housing may be added and assembled to finish the final product.

### Alternate Embodiments

Several other embodiments are contemplated by the inventors. For example controller chip 79 could be combined with flash memory chip 75 in a single BGA, small-outline, leadless, or other kind of package. Rather than use a chip package, the flash-memory die could be directly attached to the circuit board with die-wire bonding. Multiple flash-memory chips could be mounted on the circuit board, and on both sides of the board or on just one side.

In some embodiments the rear holder may be considered to have an inserted portion that is inserted within the metal tube during assembly and is not visible externally after assembly, and a cap portion that seals the rear opening but allows light from the litepipe to pass through. The front holder may be considered to have an inserted portion that is inserted within the metal tube during assembly and is not visible externally after assembly, a cap portion that seals the front opening, and a USB connector portion that extends from the cap portion in a direction opposite to the inserted portion. Terms such as front and rear are relative and used herein for convenience.

The front holder and rear holder can have grooves in their sidewalls to accept the circuit board during assembly. The circuit board can be attached to the rear holder and/or the front holder by adhesive or by clip fasteners, such as plastic snap pins or tabs that fit through and lock into holes in the circuit board. The front holder may contain clips that lock into notches or holes on the circuit board to secure the circuit board to the front holder.

Adhesive could be a thermal-bond or another type, such as a peel-off film. Adhesive films may be pressure-sensitive or heat-sensitive, but may not be used in all embodiments, such as when snaps are fully secure. For example, an adhesive could be brushed on as a liquid or paste, or it could be a double-coated adhesive film such as 3M's 7953 film. A thermal bond film (TBF) such as 3M's TBF-668 could also be used. The adhesive can be cured by heating the assembly, by pressing the case and board together, or by allowing sufficient time for curing.

Standard USB connector plugs have 2 holes on top and 2 holes on bottom. These USB holes may or may not be present on metal shield 18, plastic shield 28, or partial metal shield 31. USB holes may be present on the top but not on the bottom, or vice-versa. Removable cap 56 may be used with other embodiments as well. Features of some embodiments may be added to other embodiments.

Alignment holes and tabs or stubs may not be needed in all embodiments. Friction between the metal tube and the plastic holders may be sufficient for holding the metal tube onto the plastic parts. Additional holes, slots, and other features may be added to the metal tube or plastic parts.

Rather than use the USB device only for flash-memory storage, additional features may be added. For example, a USB music player may include a controller for playing audio from MP3 data stored in the flash memory. An audio jack may be added to the USB device to allow a user to plug in headphones to listen to the music. A wireless transmitter such as a BlueTooth transmitter may be added to the USB device to connect to wireless headphones rather than using the audio jack. Infrared transmitters such as for IrDA may also be added. A BlueTooth transceiver to a wireless mouse, PDA, keyboard, printer, digital camera, MP3 player, or other wireless device may also be added. The BlueTooth transceiver could replace the USB connector as the primary connector. A Bluetooth USB adapter device could have a USB connector, a RF (Radio Frequency) transceiver, a baseband controller, an antenna, a flash memory (EEPROM), a voltage regulator, a crystal, a LED (Light Emitted Diode), resistors, capacitors and inductors. These components may be mounted on the PCB before being enclosed into a plastic or metallic enclosure.

Snap-tabs with movable latching teeth or extensions or locking portions may also be used. Different thicknesses and dimensions can be substituted for the examples given. The USB device may have a somewhat varying width, such as within +/−20%.

Various design features such as supporting underside ribs or bumps can be added. Various features can have a variety of shapes and sizes. Oval, round, square, rectangular, trapezoidal, and other shapes may be used.

A variety of materials may be used for the connector substrate, circuit board, metal contacts, holders, metal tube, etc. The metal tube could be a hard-plastic tube coated with metal or a metal film, or even a hard plastic tube without metal.

The USB connector may be widened to accommodate extra metal contacts to become an extended-USB connector for future USB specification. Moreover, the width of the USB connector can be widened, and the height and metal contacts of the slim connector can be varied, making it into a general-purpose slim connector, for USB, extended-USB, PCI Express, mini PCI Express applications, etc.

There are 4 pins in the current USB pin out definition—VCC, GND, D+, and D−. VCC is the 5V power pin. GND is the ground pin and D+ and D− are the differential data I/O pins. For the USB 2.0 specification, data transfer rates are up to 480M bits/sec, and the power supply current is 500 mA. These might not meet future (or even some current) needs of speed and power associated with some USB devices, such as large flash memory cards.

Additional metal contacts can be added to the new connectors. These additional metal contacts can serve as power, ground, and/or I/O pins which are extensions to the USB specification, or as PCI Express (or mini PCI Express) specifications. Greater power capability can be obtained with (or without) additional power and ground pins (or by a higher power supply current of the existing power pin). Multiple power supplies can also be provided by the additional power and ground pins. The improved power supply capabilities allow more devices and/or more memory chips to be powered. Extra I/O pins can be added for higher bandwidth and data transfer speeds. The additional I/O pins can be used for multiple-bit data I/O communications, such as 2, 4, 8, 12, 16, 32, 64, . . . bits. By adopting some or all of these new features, performance of flash memory cards/devices can be significantly improved. These additional pins could be located behind or adjacent to the existing USB pins, or in various other arrangements. The additional pins could be applied to male and female connectors. New types of flash memory cards/devices can be made with these new connectors, which have the additional pins.

Any advantages and benefits described may not apply to all embodiments of the invention. When a process or manufacturing step is recited in an apparatus or product claim, Applicant intends to claim a product made by a process that includes the recited process or manufacturing step. When the word “means” is recited in a claim element, Applicant intends for the claim element to fall under 35 USC Sect. 112, paragraph 6. Often a label of one or more words precedes the word “means”. The word or words preceding the word “means” is a label intended to ease referencing of claims elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word “means” are not intended to fall under 35 USC Sect. 112, paragraph 6. Signals are typically electronic signals, but may be optical signals such as can be carried over a fiber optic line.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A metal-tube portable device with an integrated Universal-Serial-Bus (USB) connector comprising:
a circuit board having wiring traces;
an integrated circuit memory electrically connected to and mounted on the circuit board;
a USB connector having a plurality of metal contacts disposed on a first surface of a connector substrate, the plurality of metal contacts for carrying USB signals, the USB connector for inserting into and connecting with a female USB socket;
a rigid tube having a front opening and a rear opening;
a front holder that supports the circuit board, the front holder and the circuit board being inserted into the front opening of the rigid tube during assembly; and
a rear holder that is inserted into the rear opening of the rigid tube during assembly;
wherein the USB connector
(a) is an integral part of the front holder, the connector substrate being part of the front holder, or
(b) is mounted to the circuit board as a component and inserted through a slot on the front holder during assembly, or
(c) has a supporting portion that is a portion of the front holder and a circuit-board extension that contains the plurality of metal contacts, the circuit-board extension being a portion of the circuit board that fits through the slot on the front holder during assembly and is supported by the supporting portion of the front holder, the connector substrate including the circuit-board extension;
whereby the rigid tube surrounds the circuit board.

2. The metal-tube portable device with the integrated USB connector of claim 1 wherein the front holder and the rear holder are formed of plastic and the rigid tube is formed of metal and is a metal tube.

3. The metal-tube portable device with the integrated USB connector of claim 2 further comprising:
a light-emitting diode mounted to the circuit board on an end near the rear opening of the metal tube when assembled, for generating light for passing through the rear holder to indicate a status to a user.

4. The metal-tube portable device with the integrated USB connector of claim 3 further comprising:
a litepipe, disposed between the rear holder and the light-emitting diode mounted to the circuit board, the litepipe for directing light from the light-emitting diode to pass through the rear holder.

5. The metal-tube portable device with the integrated USB connector of claim 4 wherein the litepipe is fitted into the rear holder before the rear holder is inserted into the rear opening of the metal tube during assembly.

6. The metal-tube portable device with the integrated USB connector of claim 4 wherein the litepipe is fitted into the rear opening of the metal tube and over the light-emitting diode during assembly before the rear holder is inserted into the rear opening of the metal tube.

7. The metal-tube portable device with the integrated USB connector of claim 4 wherein the rear holder comprises:
an inserted portion that is inserted within the metal tube during assembly and is not visible externally after assembly, and
a cap portion that seals the rear opening but allows light from the litepipe to pass through.

8. The metal-tube portable device with the integrated USB connector of claim 2 wherein the front holder comprises:
an inserted portion that is inserted within the metal tube during assembly and is not visible externally after assembly,
a cap portion that seals the front opening, and
a USB connector portion extending from the cap portion in a direction opposite to the inserted portion.

9. The metal-tube portable device with the integrated USB connector of claim 8 wherein the rear holder supports the circuit board.

10. The metal-tube portable device with the integrated USB connector of claim 2 further comprising:
alignment holes in the metal tube;
alignment stubs on the front holder, the alignment stubs for fitting into the alignment holes in the metal tube during assembly.

11. The metal-tube portable device with the integrated USB connector of claim 2 wherein the front holder and the rear holder are connected to the metal tube by adhesive, snaps, or by friction.

12. The metal-tube portable device with the integrated USB connector of claim 2 further comprising:
a metal shield surrounding the connector substrate to protect the plurality of metal contacts on the USB connector.

13. The metal-tube portable device with the integrated USB connector of claim 2 further comprising:
a plastic shield surrounding the connector substrate to protect the plurality of metal contacts on the USB connector.

14. The metal-tube portable device with the integrated USB connector of claim 2 further comprising:
a partial plastic shield that partially surrounds the connector substrate to protect the plurality of metal contacts on the USB connector, the partial plastic shield covering the first surface of the connector substrate.

15. The metal-tube portable device with the integrated USB connector of claim 2 further comprising:
a removable cap that covers the USB connector when not inserted into the female USB socket, the removable cap being removable by a user.

16. The metal-tube portable device with the integrated USB connector of claim 2 wherein the circuit board is a printed-circuit board (PCB) containing wiring traces;
wherein the integrated circuit memory mounted to the circuit board comprises:
a flash memory chip with non-volatile memory that retains data when power is removed.

17. The metal-tube portable device with the integrated USB connector of claim 16 further comprising:
a controller chip mounted on the circuit board, for reading data from and for writing data to the flash memory chip and sending the data over the plurality of metal contacts as USB signals to the female USB socket.

18. A Universal-Serial-Bus (USB) device assembly comprising:
a circuit board having wiring traces, the circuit board having four metal contacts on an insertion end of a contact side of the circuit board, the four metal contacts for connecting to USB contacts in a USB socket when inserted;
an integrated circuit (IC) package containing a flash-memory chip with non-volatile memory, the IC package mounted to the circuit board;
a front holder for holding the circuit board, the front holder having a slot sized to allow the insertion end to pass through the slot during assembly;
a connector-supporter portion of the front holder that supports the insertion end of the circuit board that is inserted through the slot during assembly;
a rear holder that supports a rear edge of the circuit board, the rear edge opposite the insertion end;
a rigid tube having an insertion-end opening and a rear opening, the rigid tube disposed around the circuit board when assembled;
a front insertion portion of the front holder for inserting into the insertion-end opening of the rigid tube during assembly, the front insertion portion being hidden from view by the rigid tube after assembly;
a rear insertion portion of the rear holder for inserting into the rear opening of the rigid tube during assembly, the rear insertion portion being hidden from view by the rigid tube after assembly;
wherein the insertion end of the circuit board is inserted through the slot of the front holder during a first assembly step to generate a sub-assembly;
the four metal contacts being exposed to contact the USB contacts when the connector-supporter portion of the front holder is inserted into the USB socket; and
wherein sub-assembly of the front holder and the circuit board are together inserted into the insertion-end opening of the rigid tube, and the rear insertion portion of the rear holder is inserted into the rear opening of the rigid tube to assemble the USB device assembly.

19. The USB device assembly of claim 18 wherein the rigid tube is a metal tube and the front holder and the rear holder are formed of plastic.

20. A Universal-Serial-Bus (USB) plug device comprising:
circuit board means for supporting integrated circuits;
rigid tube means for rigidly and partially enclosing the circuit board means;
front holder-connector means for supporting a first end of the circuit board means;
USB connector means, on the front holder-connector means, for insertion into a USB socket;
four metal contact means for contacting metal contacts in the USB socket, the four metal contact means being formed on the USB connector means or on an extension of the circuit board means that is fitted through a slot of the front holder-connector means onto the USB connector means;
rear holder means for supporting a second end of the circuit board means that is opposite to the first end;
rear insertion means, on the rear holder means, for insertion into a rear opening of the rigid tube means during assembly; and
front insertion means, on the front holder-connector means, for insertion into a front opening of the rigid tube means during assembly,
whereby the circuit board means is supported by the front holder-connector means and by the rear holder means which are inserted into front and rear openings of the rigid tube means.

21. The USB plug device of claim 20
wherein the rigid tube means is a metal tube;
wherein the front holder-connector means is a plastic part;
wherein the rear holder means is a plastic part.
